(19) United States
(12) Patent Application Publication
(10) Pub. No.: US 2010/0024840 A1
(43) Pub. Date: Feb. 4, 2010

(54) CHAMBER PLASMA-CLEANING PROCESS SCHEME

(76) Inventors: CHANG-LIN HSIEH, San Jose, CA (US); Chi-Hong Ching, Santa Clara, CA (US); Hidehiro Kojiri, Sunnyvale, CA (US); Joshua Tsui, Santa Clara, CA (US)

Correspondence Address: APPLIED MATERIALS/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/181,535

(22) Filed: Jul. 29, 2008

(51) Int. Cl. B08B 6/00

(52) U.S. Cl. 134/1.1

(57) ABSTRACT

A method for plasma-cleaning a chamber in a process tool is described. A substrate is placed on a chuck in a process chamber having a set of contaminants therein. A plasma process is executed in the process chamber to transfer the set of contaminants to the top surface of the substrate. The substrate, having the set of contaminants thereon, is removed from the process chamber.

### BACKGROUND

1) Field

Embodiments of the present invention are in the field of Semiconductor Processing and, in particular, semiconductor processing equipment cleaning schemes.

2) Description of Related Art

For the past several decades, the scaling of features in integrated circuits has been a driving force behind an ever-growing semiconductor industry. Scaling to smaller and smaller features enables increased densities of functional units on the limited real estate of semiconductor chips. For example, shrinking transistor size allows for the incorporation of an increased number of memory or logic devices on a chip, lending to the fabrication of products with increased capacity. The drive for ever-more capacity, however, is not without issue. Tolerances in variations of the critical dimension from one device to another have become very constrained. Thus, any imperfections in a process step used to fabricate devices may unacceptably compromise the performance of the devices.

The stringent requirements for low process variations has placed a substantial burden on equipment manufacturers. In addition to addressing requirements of high throughput, process tools must also exhibit high intra-wafer uniformity as well as run-to-run consistency for a batch of production wafers. Equipment manufacturers therefore usually require customers to perform very detailed and time consuming preventative maintenance (PM) schemes to ensure wafer-to-wafer and run-to-run uniformity and consistency. However, such PM schemes can substantially impact the throughput of the process tool if long periods of tool idle time are required. This may lead to unacceptable delays in a semiconductor fabrication production line.

### SUMMARY

Embodiments of the present invention include methods for plasma-cleaning a chamber in a process tool. In one embodiment, a substrate (e.g., a wafer) is placed on a chuck in a process chamber having a set of contaminants therein. A plasma process is then executed in the process chamber to transfer the set of contaminants to the top surface of the substrate. The substrate, having the set of contaminants thereon, is removed from the process chamber. In a specific embodiment, the set of contaminants includes particles such as, but not limited to, metal particles and dielectric particles. In another specific embodiment, the plasma process is a low-pressure plasma process carried out at a pressure approximately in the range of 5-50 mTorr.

In another embodiment, a substrate is placed to cover a top surface of a chuck in a process chamber having a set of contaminants therein. A first plasma process is executed in the process chamber to transfer the set of contaminants to the top surface of the substrate. The substrate, having the set of contaminants thereon, is then removed from the process chamber. While the substrate is situated in the process chamber, a second plasma process is executed in the process chamber to season the process chamber. A third plasma process is executed in the process chamber while the top surface of the chuck is exposed.

Another embodiment includes a method for operating an etch process tool. A first substrate is provided on a chuck in a process chamber. The first substrate is etched with a first plasma process in the process chamber. The etching provides a set of contaminants in the process chamber. The first substrate is then removed from the process chamber. A second substrate is then placed to cover a top surface of the chuck in the process chamber. A second plasma process is executed in the process chamber to transfer the set of contaminants to the top surface of the second substrate. The second substrate, having the set of contaminants thereon, is then removed from the process chamber. A third plasma process is executed in the process chamber while the top surface of the chuck is exposed.

### BRIEF DESCRIPTION OF THE DRAWINGS

FIG. 1 illustrates a cross-sectional view of a plasma process chamber, in accordance with an embodiment of the present invention.

FIG. 2 depicts a plot of Critical Dimension (CD) of an etch process as a function of Chamber Run Time, in accordance with an embodiment of the present invention.

FIG. 3 depicts a Flowchart representing a series of operations in a method for plasma-cleaning a chamber in a process tool, in accordance with an embodiment of the present invention.

FIG. 4A illustrates a cross-sectional view of a plasma process chamber having a first substrate (e.g., a wafer) etched therein by a first plasma process, wherein the etching provides a set of contaminants in the process chamber, in accordance with an embodiment of the present invention.

FIG. 4B illustrates a cross-sectional view of a plasma process chamber having a second substrate (e.g., a wafer) exposed to a second plasma process therein, wherein the plasma process transfers the set of contaminants to the top surface of the second substrate, in accordance with an embodiment of the present invention.

FIG. 4C illustrates a cross-sectional view of a plasma process chamber having a no substrate therein, wherein a third plasma process is carried out in the plasma process chamber, in accordance with an embodiment of the present invention.

FIG. 5 depicts a Flowchart representing a series of operations in a method for operating an etch process tool, in accordance with an embodiment of the present invention.

FIG. 6 illustrates a cross-sectional, view of an exemplary multi-frequency etch system in which a chamber plasma-cleaning process can be performed, in accordance with an embodiment of the present invention.

### DETAILED DESCRIPTION

A method for plasma-cleaning a chamber in a process tool is described. In the following description, numerous specific details are set forth, such as plasma conditions and material regimes, in order to provide a thorough understanding of the present invention. It will be apparent to one skilled in the art that the present invention may be practiced without these specific details. In other instances, well-known features, such as semiconductor substrate fabrication techniques, are not described in detail in order to not unnecessarily obscure the present invention. Furthermore, it is to be understood that the various embodiments shown in the Figures are illustrative representations and are not necessarily drawn to scale.

Disclosed herein is a method for plasma-cleaning a chamber in a process tool. The method may include placing a substrate, such as a wafer, on a chuck in a process chamber having a set of contaminants therein. In one embodiment, a plasma process is then executed in the process chamber to transfer the set of contaminants to the top surface of the substrate. Then, the substrate, having the set of contaminants thereon, may be removed from the process chamber. In a specific embodiment, the set of contaminants includes particles such as, but not limited to, metal particles and dielectric particles. In another specific embodiment, the plasma process is a low-pressure plasma process carried out at a pressure approximately in the range of 5-50 mTorr.

Performing a chamber plasma-cleaning process while a substrate is situated on the top surface of a chuck may enable a reduction in critical dimension (CD) variation throughout the run lifetime of the chamber. For example, in accordance with an embodiment of the present invention, a plasma-cleaning process is carried out in a process chamber while a substrate rests on, and effectively blocks, the top surface of the chuck in the process chamber. In the absence of a substrate covering the chuck, contaminants adhering to the chamber walls or showerhead might otherwise land on the top surface of the chuck during the plasma-cleaning process. As product substrates are subsequently processed, e.g. etched, in the chamber the presence of such contaminants on the chuck can lead to hot spots in the product substrate as it rests on the chuck. These hot spots can affect the etching characteristics and can result in undesirable CD variations etched into the product substrate. Instead, in one embodiment, a dummy or seasoning substrate is used to cover the chuck during the plasma-cleaning process. In that embodiment, during the plasma-cleaning process, contaminants located in the process chamber are transferred to the dummy or seasoning substrate instead of to the top of the chuck. Accordingly, in an embodiment, the contaminants are removed from the process chamber upon removal of the dummy or seasoning substrate from the process chamber.

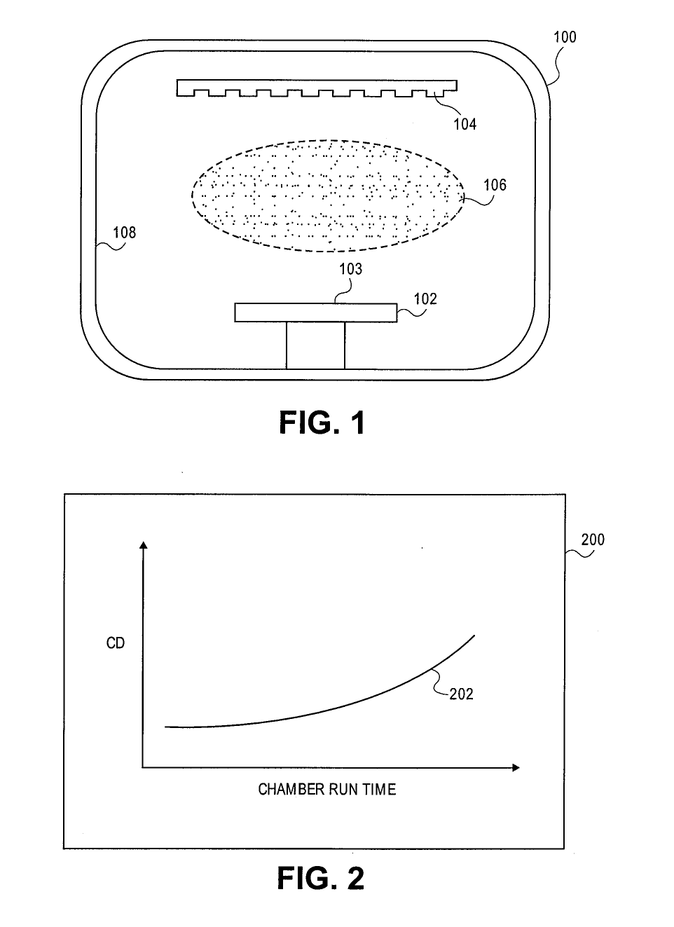

In an aspect of the invention, a process chamber (e.g. an etch chamber) in a process tool may become contaminated during the processing of production substrates in the process chamber. FIG. 1 illustrates a cross-sectional view of a plasma process chamber, in accordance with an embodiment of the present invention.

Referring to FIG. 1, a process chamber 100 includes a chuck 102 and a showerhead 104. Under typical processing conditions, a sample (e.g. a production substrate or a production wafer) is placed on a top surface 103 of chuck 102. Plasma source gases are then flowed into and dispersed evenly in process chamber 100 via showerhead 104. A plasma 106 is then struck in between showerhead 104 and chuck 102. Plasma 106 may be used to etch features in the production substrate.

During the etching of a product substrate with plasma 106, contaminants may be generated from the production substrate and may adhere to showerhead 104 and even to chamber walls 108 of process chamber 100. The accumulation of contaminants formed as a batch of production substrates is cycled through the process chamber for etching may impact the quality and repeatability of the etch process over time. For example, in one embodiment, the accumulation of contaminants on showerhead 104 leads to a variation in etch rate from one region of a production substrate to another region of the same production substrate, or from one production substrate to the next. The variation may be a result of portions of showerhead 104 becoming blocked by contaminants, hindering the flow of process gases through showerhead 104. In another embodiment, the accumulation of contaminants on chamber walls 108 can ultimately lead to the undesirable flaking of chunks of the contaminants onto a production substrate. A wet clean of the process chamber can be carried out to remove the contaminants, but it may be inefficient to perform such a wet clean more frequently than every few days in a production line.

Accordingly, it may be desirable to carry out a substrate-less chamber plasma-cleaning process after a certain number of production substrates has been etched in process chamber 100. Typical substrate-less plasma-cleaning processes involve the use of a high-pressure plasma process carried out in chamber 100 in the absence of a substrate on chuck 104. Such substrate-less plasma-cleaning processes may be carried out more frequently than a wet clean of clamber 100, such as between the etching of every product substrate, without impacting the timing of the production line. However, in accordance with an embodiment of the present invention, such a substrate-less plasma cleaning process can transfer contaminants from showerhead 104 or chamber walls 108 onto top surface 103 of chuck 102. Furthermore, in a specific embodiment, a high pressure substrate-less plasma cleaning process may not completely remove contaminants from showerhead 104 or chamber walls 108.

The transfer of contaminants onto top surface 103 of chuck 102 during a substrate-less chamber plasma-cleaning process may detrimentally impact etch processes applied to production substrates subsequent to carrying out the chamber plasma-cleaning process. For example, in one embodiment, the accumulation of contaminants onto top surface 103 of chuck 102 leads to a variation in CD from one production substrate to the next. FIG. 2 depicts a plot 200 of Critical Dimension (CD) of an etch process as a function of Chamber Run Time, in accordance with an embodiment of the present invention.

Referring to FIG. 2, a curve 202 represents the relationship between CD and chamber run time. Chamber run time is the time accumulation for production substrates processed following a wet clean of a process chamber. A substrate-less plasma-clean is carried out, e.g., between the etching of each production substrate in a batch of production substrates. In one embodiment, as more production substrates are processed, the CD of the substrates starts to increase, as depicted in FIG. 2. In an embodiment, the CD increase is attributable to the transfer of contaminants to top surface 103 of chuck 102 during substrate-less plasma-cleaning processes. The contaminants lead to the formation of hot spots on chuck 102 at the same time that a production substrate is etched in chamber 100. These hot spots may change the local etch characteristics of the plasma at a sample surface, leading to variable CDs on the production substrate.

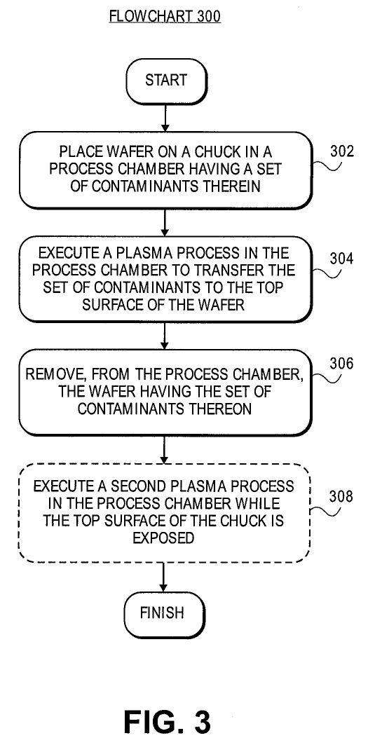

Accordingly, an aspect of the present invention includes a method for plasma-cleaning a chamber in a process tool. FIG. 3 depicts a Flowchart 300 representing a series of operations in a method for plasma-cleaning a chamber in a process tool, in accordance with an embodiment of the present invention.

Referring to operation 302 of Flowchart 300, a substrate (e.g., a wafer) is placed on a chuck in a process chamber having a set of contaminants therein. In one embodiment, the substrate is a dummy wafer or a seasoning wafer such as, but not limited to, a bare silicon wafer or a wafer coated with thermally grown oxide. In a specific embodiment, the wafer is a 300 mm wafer and the process chamber is housed in a tool suitable for processing 300 mm wafers. In an embodiment, the set of contaminants includes particles such as, but not limited to, metal particles or dielectric particles.

Referring to operation 304 of Flowchart 300, a plasma process is then executed in the process chamber to transfer the set of contaminants to the top surface of the substrate. In accordance with an embodiment of the present invention, the plasma process is a low-pressure plasma process carried out at a pressure approximately in the range of 5-50 mTorr. In a specific embodiment, the plasma process is carried out at a pressure of approximately 10 mTorr. The use of a low-pressure plasma process at this operation may enable a more thorough cleaning of the parts of the process chamber, such as the showerhead and the chamber walls, than does a high pressure plasma process. For example, in one embodiment, the cleaning pattern starts at the center of the ceiling of the process chamber and migrates thoroughly to the walls of the process chamber.

The plasma used for the plasma-cleaning process of operation 304 may be based on a gas suitable to bombard contaminants located on various parts of the process chamber and to transfer the contaminants to the top surface of the substrate which can be a dummy or seasoning wafer, as previously mentioned. For example, in an embodiment, the plasma for the plasma-cleaning process is based on a gas such as, but not limited to, oxygen or argon gas. In one embodiment, the plasma process is based on oxygen gas having a flow rate approximately in the range of 500-2000 standard cubic centimeters per minute (sccm) and is carried out for a duration approximately in the range of 60-200 seconds. In a specific embodiment, the plasma process is based on oxygen gas having a flow rate of approximately 1500 sccm and is carried out for a duration of approximately 180 seconds. In an embodiment, the process chamber has a top electrode and a bottom electrode, and the top electrode has a source power approximately in the range of 500-2000 Watts while the bottom electrode has a source power of approximately 0 Watts (no bias) during the plasma process. In a specific embodiment, the top electrode has a source power of approximately 1000 Watts while the bottom electrode has a source power of approximately 0 Watts during the plasma process.

Referring to operation 306 of Flowchart 300, the substrate, having the set of contaminants thereon, is then removed from the process chamber. Thus, the set of contaminants is removed from the process chamber without becoming situated on the surface of the chuck. For example in accordance with an embodiment of the present invention, prior to executing the plasma-cleaning process, the set of contaminants is situated on a showerhead housed in the process chamber. Using a low-pressure plasma-cleaning process, the set of contaminants is removed from the tool because the set of contaminants is transferred to the surface of the substrate instead of to the top surface of the chuck.

In an additional aspect of the invention, a second plasma-cleaning process operation may be carried out following the plasma-cleaning process described in association with operations 302, 304 and 306 from Flowchart 300. Referring to operation 308 of Flowchart 300, a second plasma process may be executed in the process chamber while the top surface of the chuck is exposed.

The second plasma process may be used to remove other contaminants or impurities that are not readily transferred out of the process chamber according to the low-pressure plasma-cleaning process scheme from operations 302, 304 and 306. For example, in one embodiment, the second plasma process consumes organic contaminants situated in the process chamber. In accordance with an embodiment of the present invention, the second plasma-cleaning process relies on a high pressure plasma to convert contaminants or impurities (such as organic contaminants or impurities) to volatile species that can be pumped out of the process chamber. Thus, a substrate (e.g., a wafer) need not be used to cover the chuck at this operation because the second plasma volatilizes, as opposed to bombards and transfers, the remaining contaminants or impurities. It may even be preferable to have the top of the chuck exposed so that the top surface of the chuck may be cleaned by the second plasma process.

The plasma used for the second plasma-cleaning process of operation 308 may be based on a gas suitable to volatilize contaminants located on various parts of the process chamber. For example, in accordance with an embodiment of the present invention, the second plasma-cleaning process is carried out at a substantially higher pressure than the first plasma-cleaning process. In an embodiment, the first plasma-cleaning process is a low-pressure plasma process carried out at a pressure approximately in the range of 5-50 mtorr, and the second plasma-cleaning process is a high-pressure plasma process carried out at a pressure approximately in the range of 200-600 mTorr. In a specific embodiment, the first plasma-cleaning process is a low-pressure plasma process carried out at a pressure of approximately 10 mTorr, and the second plasma-cleaning process is a high-pressure plasma process carried out at a pressure of approximately 300 mTorr. In one embodiment, the second plasma process is based on oxygen gas having a flow rate approximately in the range of 500-4000 sccm and is carried out for a duration approximately in the range of 10-60 seconds. In a specific embodiment, the second plasma process is carried out for a duration of approximately 30 seconds. In an embodiment, the process chamber has a top electrode and a bottom electrode, and the top electrode has a source power approximately in the range of 0-100 Watts while the bottom electrode has a source power of approximately 0 Watts (no bias) during the second plasma process.

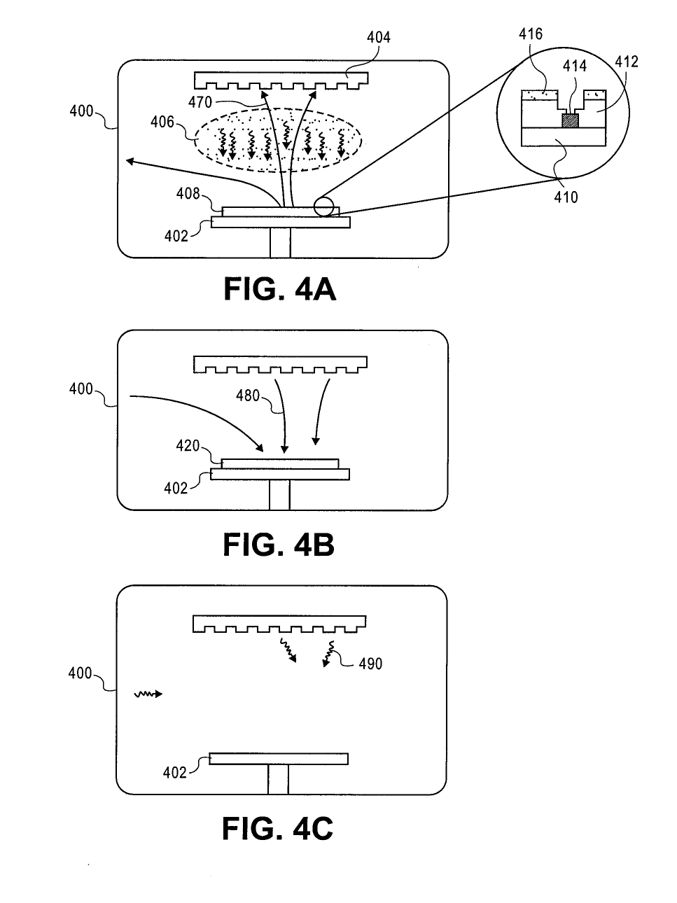

In an aspect of the present invention, a chamber plasma-cleaning process is performed following the contamination of a process chamber with a set of contaminants. FIGS. 4A-4C illustrate cross-sectional views of a plasma process chamber in which a plasma-cleaning process scheme is performed, in accordance with an embodiment of the present invention.

FIG. 4A illustrates a cross-sectional view of a plasma process chamber 400 having a production substrate 408, which in one embodiment is a production wafer, etched therein by a first plasma process 406, wherein the etching provides a set of contaminants in the process chamber, in accordance with an embodiment of the present invention. Production substrate 408 sits above and covers a portion of the top surface of a chuck 402, and sits below a showerhead 404 housed in plasma process chamber 400. Production substrate 408 may include a variety of blanket or patterned stack of materials typically used in the semiconductor industry. For example, in one embodiment, production substrate 408 includes a substrate 410, a patterned dielectric layer 412, and a metal feature 414, as depicted in the magnified portion of FIG. 4A. In accordance with an embodiment of the present invention, a set of contaminants is generated and dispersed in plasma process chamber 400, as depicted by arrows 470, while an etch process is performed on production substrate 408. In an embodiment, the set of contaminants is dispersed onto and blocks portions of showerhead 404. In one embodiment, production substrate 408 includes a metal layer and a dielectric layer and the set of contaminants includes particles such as, but not limited to, metal particles or dielectric particles. In an additional embodiment, other contaminants, such as organic residues, are dispersed in plasma process chamber 400. In a specific embodiment, the organic residues are generated from a layer of photo-resist 416 on production substrate 408. Following the etching of production substrate 408 by the first plasma process, production substrate 408 is removed from plasma process chamber 400.

FIG. 4B illustrates a cross-sectional view of plasma process chamber 400 having a dummy or seasoning substrate 420, which in one embodiment is a dummy or seasoning wafer, exposed to a second plasma process therein, wherein the plasma process transfers the set of contaminants to the top surface of dummy or seasoning substrate 420, in accordance with an embodiment of the present invention. Referring to FIG. 4B, dummy or seasoning substrate 420 is placed to cover a portion of the top surface of chuck 402 in plasma process chamber 400. The second plasma process is executed in plasma process chamber 400 to transfer the set of contaminants to the top surface of dummy or seasoning substrate 420, as depicted by the arrows 480. In one embodiment, the set of contaminants includes metal particles or dielectric particles generated during the etching of production substrate 408. In accordance with an embodiment of the present invention, the second plasma process is a low-pressure plasma process such as the low-pressure plasma process described in association with operation 304 from Flowchart 300. In an embodiment, a third plasma process is executed in plasma process chamber 400 to season plasma process chamber 400, while dummy or seasoning substrate 420 is situated in plasma process chamber 400. Following execution of either the second or the third plasma process, dummy or seasoning substrate 420, having the set of contaminants thereon, is removed from plasma process chamber 400.

FIG. 4C illustrates a cross-sectional view of plasma process chamber 400 having no substrate therein while a substrate-less or a wafer-less plasma process is carried out in plasma process chamber 400, in accordance with an embodiment of the present invention. Referring to FIG. 4C, the substrate-less plasma process is executed in plasma process chamber 400 while the top surface of chuck 402 is exposed. In an embodiment, the substrate-less plasma process is a high-pressure plasma process such as the high-pressure plasma process described in association with operation 308 from Flowchart 300. In one embodiment, the substrate-less plasma process is used to volatilize organic residues remaining in plasma process chamber 400, as depicted by the squiggly arrows 490.

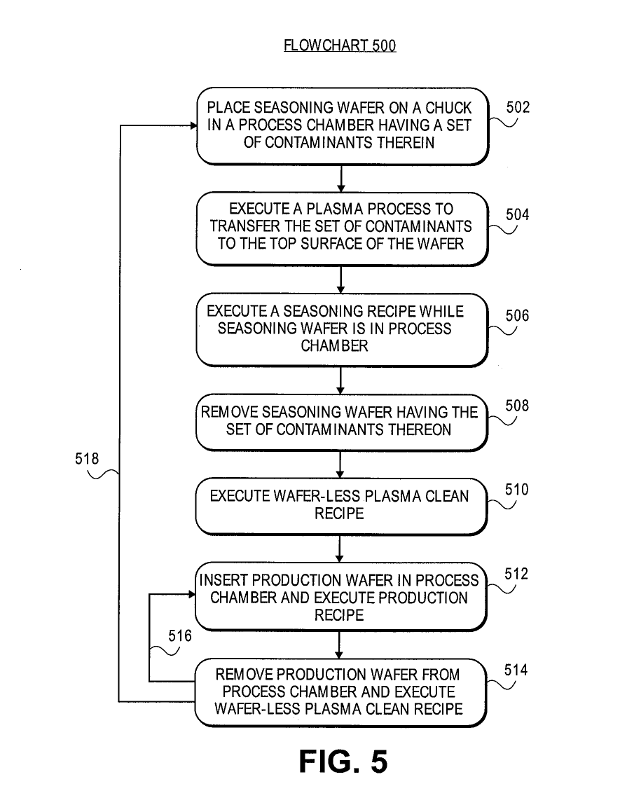

In an aspect of the invention, a chamber plasma-cleaning process scheme may be incorporated into a production line integration scheme. For example, FIG. 5 depicts a Flowchart 500 representing a series of operations in a method for operating an etch process tool, in accordance with an embodiment of the present invention.

Referring to operation 502 of Flowchart 500, a seasoning substrate is placed on a chuck in a process chamber having a set of contaminants therein. The seasoning substrate and the set of contaminants may be a seasoning wafer and a set of contaminants described in association with operation 302 from Flowchart 300. In accordance with an embodiment of the present invention, a seasoning substrate is a wafer to which a production etch recipe is applied in the process chamber prior to running the production etch recipe on an actual production wafer.

Referring to operation 504 of Flowchart 500, a plasma-cleaning process is performed by executing a plasma process in the process chamber while the seasoning substrate, or the seasoning wafer, is situated on the chuck. This operation is carried out in order to transfer the set of contaminants from, e.g., the process chamber walls or the process chamber showerhead to the top surface of the seasoning substrate. In one embodiment, the plasma-cleaning process is a low-pressure plasma process such as the low-pressure plasma process described in association with operation 304 from Flowchart 300.

Referring to operation 506 of Flowchart 500, a seasoning recipe is executed in the process chamber to season the process chamber, while the seasoning substrate is present on the chuck in the process chamber. In accordance with an embodiment of the present invention, the seasoning recipe is the same etch recipe that will be used to subsequently etch a production substrate in the process chamber. In an additional embodiment, an ash recipe is performed following the seasoning recipe, while the seasoning substrate is still situated on the chuck in the process chamber. In one embodiment, the ash recipe used is similar or the same as an ash recipe performed on a subsequently processed production substrate. Such seasoning (i.e. etch) and ash recipes may involve the use of several plasma gases and a variety of process conditions, as are known in the art.

Referring to operation 508 of Flowchart 500, the seasoning substrate, having the set of contaminants thereon, is removed from the process chamber. Then, referring to operation 510 of Flowchart 500, a substrate-less or wafer-less plasma-cleaning recipe is carried out in the process chamber. In one embodiment, the substrate-less plasma-cleaning process is a high-pressure plasma process, such as the high-pressure plasma process described in association with operation 308 from Flowchart 300.

At this point, the process chamber plasma-cleaning and seasoning operations may be complete and a production substrate, or a batch of production substrates, may be processed in the process chamber. Referring to operation 512 of Flowchart 500, a production substrate is inserted into the process chamber and a production recipe is executed on the production substrate. For example, in accordance with an embodiment of the present invention, the production substrate is etched with a recipe that is the same or similar to the seasoning recipe described in association with operation 506. An ash recipe may also be performed on the production substrate following execution of the etch recipe, mirroring the process sequence described in association with operation 506.

Referring to operation 514 of Flowchart 500, the production substrate, or production wafer, is removed from the process chamber and a substrate-less or wafer-less plasma clean recipe is performed in the process chamber. In one embodiment, the substrate-less plasma-cleaning process is a high-pressure plasma process, such as the high-pressure plasma process described in association with operation 308 from Flowchart 300 or operation 508 above. Depending on the requirements of the production line, operations 512 and 514 may be cycled through multiple times, as depicted by cycle arrow 516. For example, in one embodiment, operations 512 and 514 are cycled through 25 times to accommodate a single batch of 25 production substrates.

Referring to cycle arrow 518, once a desired number of operation 512/514 cycles is completed, the plasma-cleaning operations 502 through 510 may be performed prior to processing another batch of production substrates or production wafers. Then, the two cycles 516 and 518 may be repeated until a preventative maintenance (PM) process, such as a wet clean, need be performed on the process chamber. In accordance with an embodiment of the present invention, by incorporating a low-pressure plasma-cleaning process in to the production sequencing of a process chamber, the number of production substrates that can be processed prior to a PM process is required is approximately three times the number of production substrates that can be processed if a low-pressure plasma-cleaning process is not used. In one embodiment, by incorporating a low-pressure plasma-cleaning process into the production sequencing of a process chamber, a process chamber can be used for approximately 1000 process hours between PM processes.

Chamber plasma-cleaning process schemes, such as those described above, may be employed in a variety of etch or reaction chambers. For example, in one embodiment, a chamber plasma-cleaning process is carried out in a plasma etch chamber capable of energizing an etchant gas mixture with multiple RF frequencies, such as the Enabler™ etch chamber manufactured by Applied Materials of CA, USA. In another embodiment, a chamber plasma-cleaning process is performed in a magnetically enhanced reactive ion etcher (MERIE) etch chamber, such as the MxP®, MxP+™, Super-E™ or E-MAX®chamber, also manufactured by Applied Materials of CA, USA. A chamber plasma-cleaning process may also be performed in other types of high performance etch chambers known in the art, for example, chambers in which a plasma is formed using inductive techniques.

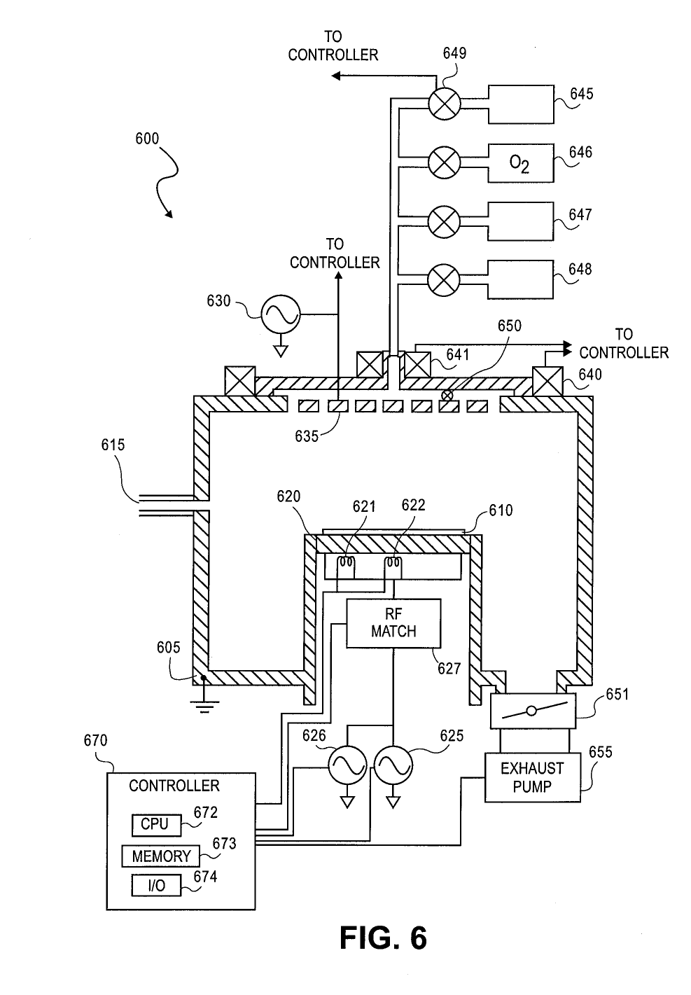

A cross-sectional view of an exemplary multi-frequency etch system 600 in which a chamber plasma-cleaning process can be performed, such as the Enabler™ etch chamber, is shown in FIG. 6. System 600 includes a grounded chamber 605. A dummy or seasoning substrate 610, which in one embodiment is a dummy or seasoning wafer, is loaded through an opening 615 and clamped to a temperature controlled cathode 620. In particular embodiments, temperature controlled cathode 620 includes a plurality of zones, each zone independently controllable to a temperature set-point, such as with a first thermal zone 622 proximate a center of substrate 610 and a second thermal zone 621 proximate to a periphery of substrate 610. Process gases, are supplied from gas sources 645, 646, 647 and 648 through respective mass flow controllers 649 to the interior of chamber 605. In certain embodiments, a NSTU 650 provides for a controllable inner to outer diameter gas flow ratio whereby process gases may be provided at a higher flow rate proximate to a center of substrate 610 or proximate a periphery of substrate 610 for tuning of the neutral species concentration across the diameter of substrate 610. Chamber 605 is evacuated to reduced pressures via an exhaust valve 651 connected to a high capacity vacuum pump stack 655 including a turbo molecular pump.

When RF power is applied, a plasma is formed in the chamber processing region over substrate 610. Bias power RF generator 625 is coupled to cathode 620. Bias power RF generator 625 provides bias power to further energize the plasma. Bias power RF generator 625 typically has a low frequency between about 2 MHz to 60 MHz, and in a particular embodiment, is in the 13.56 MHz band. In certain embodiments, the plasma etch system 600 includes an additional bias power RF generator 626 at a frequency at about the 2 MHz band which is connected to the same RF match 627 as bias power RF generator 625. Source power RF generator 630 is coupled through a match (not depicted) to a showerhead 635 which may be anodic relative to cathode 620 to provide high frequency source power to energize the plasma. Source RF generator 630 typically has a higher frequency than the bias RF generator 625, such as between 100 and 180 MHz, and in a particular embodiment, is in the 162 MHz band. Bias power affects the bias voltage on substrate 610, controlling ion bombardment of substrate 610, while source power affects the plasma density relatively independently of the bias on substrate 610. It is noted that the etch performance of a given set of input gases from which the plasma is generated varies significantly with a plasma density and substrate bias, thus both the amount and frequency of power energizing the plasma are important. Because substrate diameters have progressed over time, from 150 mm, 200 mm, 300 mm, etc., it is common in the art to normalize the source and bias power of a plasma etch system to the substrate area.

In particular embodiments, the plasma etch chamber includes a CSTU for a controlling inner and out diameter magnetic field strength ratio to control the density of charged species in the plasma across the diameter of the substrate 610. One exemplary CSTU includes the magnetic coil 640 proximate a periphery of substrate 610 and the magnetic coil 641 proximate a center of substrate 610 to provide a magnetic field of between 0 G and about 25 G in either or both of an inner zone and outer zone of chamber 605.

In an embodiment of the present invention, system 600 is computer controlled by controller 670 to control the low frequency bias power, high frequency source power, CSTU inner to outer magnetic field ratio, etchant gas flows and NSTU inner to outer flow ratios, process pressure and cathode temperatures, as well as other process parameters. Controller 670 may be one of any form of general-purpose data processing system that can be used in an industrial setting for controlling the various subprocessors and subcontrollers. Generally, controller 670 includes a central processing unit (CPU) 672 in communication with memory 673 and input/output (I/O) circuitry 674, among other common components. Software commands executed by CPU 672 cause system 600 to, for example, load a substrate into chamber 605, introduce a plasma-cleaning process gas, such as O₂, into chamber 605 and transfer contaminants to the top surface of the substrate. Other processes, such as etching an inorganic dielectric cap layer over a metal layer on a product substrate, in accordance with the present invention, may also be executed by controller 670. Aspects of the present invention may be provided as a computer program product, which may include a computer-readable medium having stored thereon instructions, which may be used to program a computer (or other electronic devices) to load a dummy or seasoning substrate into chamber 605 and introduce a plasma-cleaning gas, such as O₂, into the chamber 605, in accordance with an embodiment of the present invention. The computer-readable medium may include, but is not limited to, floppy diskettes, optical disks, CD-ROMs (compact disk read-only memory), magneto-optical disks, ROMs (read-only memory), RAMs (random access memory), EPROMs (erasable programmable read-only memory), EEPROMs (electrically-erasable programmable read-only memory), magnet or optical cards, flash memory, or other commonly known type computer-readable storage media suitable for storing electronic instructions. Moreover, the present invention may also be downloaded as a program file containing a computer program product, wherein the program file may be transferred from a remote computer to a requesting computer.

Thus, a method for plasma-cleaning a chamber in a process tool has been disclosed. In accordance with an embodiment of the present invention, a substrate is placed on a chuck in a process chamber having a set of contaminants therein. A plasma process is then executed in the process chamber to transfer the set of contaminants to the top surface of the substrate. Then, the substrate, having the set of contaminants thereon, is removed from the process chamber. In one embodiment, the set of contaminants includes particles such as, but not limited to, metal particles and dielectric particles. In another embodiment, the plasma process is a low-pressure plasma process carried out at a pressure approximately in the range of 5-50 mTorr.

What is claimed is:

1. A method for plasma-cleaning a chamber in a process tool, comprising:
placing a substrate on a chuck in a process chamber having a set of contaminants therein;
executing a plasma process in said process chamber to transfer said set of contaminants to the top surface of said substrate; and
removing, from said process chamber, said substrate having said set of contaminants thereon.

2. The method of claim 1, wherein said set of contaminants includes particles selected from the group consisting of metal particles and dielectric particles.

3. The method of claim 1, wherein said plasma process is a low-pressure plasma process carried out at a pressure approximately in the range of 5-50 mTorr.

4. The method of claim 3, wherein said plasma process is based on oxygen gas having a flow rate approximately in the range of 500-2000 standard cubic centimeters per minute (sccm) and is carried out for a duration approximately in the range of 60-200 seconds.

5. The method of claim 1, wherein said process chamber has a top electrode and a bottom electrode, and wherein said top electrode has a source power approximately in the range of 500-2000 Watts and said bottom electrode has a source power of approximately 0 Watts during said plasma process.

6. The method of claim 1, wherein, prior to executing said plasma process, said set of contaminants is situated on a showerhead housed in said process chamber.

7. A method for plasma-cleaning a chamber in a process tool, comprising:
placing a substrate to cover a top surface of a chuck in a process chamber having a set of contaminants therein;
executing a first plasma process in said process chamber to transfer said set of contaminants to the top surface of said substrate;
executing, while said substrate is situated in said process chamber, a second plasma process in said process chamber to season said process chamber;
removing, from said process chamber, said substrate having said set of contaminants thereon; and
executing a third plasma process in said process chamber while said top surface of said chuck is exposed.

8. The method of claim 7, wherein said set of contaminants includes particles selected from the group consisting of metal particles and dielectric particles.

9. The method of claim 8, wherein said third plasma process consumes organic contaminants situated in said process chamber.

10. The method of claim 7, wherein said first plasma process is a low-pressure plasma process carried out at a pressure approximately in the range of 5-50 mTorr, and wherein said third plasma process is a high-pressure plasma process carried out at a pressure approximately in the range of 200-600 mTorr.

11. The method of claim 10, wherein said first plasma process is based on oxygen gas having a flow rate approximately in the range of 500-2000 standard cubic centimeters per minute (sccm) and is carried out for a duration approximately in the range of 60-200 seconds, and wherein said third plasma process is based on oxygen gas having a flow rate approximately in the range of 500-4000 sccm and is carried out for a duration approximately in the range of 10-60 seconds.

12. The method of claim 7, wherein said process chamber has a top electrode and a bottom electrode, wherein said top electrode has a source power approximately in the range of 500-2000 Watts and said bottom electrode has a source power of approximately 0 Watts during said first plasma process, and wherein said top electrode has a source power approximately in the range of 0-100 Watts and said bottom electrode has a source power of approximately 0 Watts during said third plasma process.

13. The method of claim 7, wherein, prior to executing said first plasma process, said set of contaminants is situated on a showerhead housed in said process chamber.

14. A method for operating an etch process tool, comprising:
providing a first substrate on a chuck in a process chamber;
etching said first substrate with a first plasma process in said process chamber,
wherein the etching provides a set of contaminants in said process chamber;
removing said first substrate from said process chamber;
placing a second substrate to cover a top surface of said chuck in said process chamber;
executing a second plasma process in said process chamber to transfer said set of contaminants to the top surface of said second substrate;
removing, from said process chamber, said second substrate having said set of contaminants thereon; and
executing a third plasma process in said process chamber while said top surface of said chuck is exposed.

15. The method of claim 14, wherein said first substrate includes a metal layer and a dielectric layer, and wherein set of contaminants includes particles selected from the group consisting of metal particles and dielectric particles.

16. The method of claim 15, wherein said first substrate further includes a photo-resist layer, and wherein said third plasma process consumes organic contaminants situated in said process chamber.

17. The method of claim 14, wherein said second plasma process is a low-pressure plasma process carried out at a pressure approximately in the range of 5-50 mTorr, and wherein said third plasma process is a high-pressure plasma process carried out at a pressure approximately in the range of 200-600 mTorr.

18. The method of claim 17, wherein said second plasma process is based on oxygen gas having a flow rate approximately in the range of 500-2000 standard cubic centimeters per minute (sccm) and is carried out for a duration approximately in the range of 60-200 seconds, and wherein said third plasma process is based on oxygen gas having a flow rate approximately in the range of 500-4000 sccm and is carried out for a duration approximately in the range of 10-60 seconds.

19. The method of claim 14, wherein said process chamber has a top electrode and a bottom electrode, wherein said top electrode has a source power approximately in the range of 500-2000 Watts and said bottom electrode has a source power of approximately 0 Watts during said second plasma process, and wherein said top electrode has a source power approximately in the range of 0-100 Watts and said bottom electrode has a source power of approximately 0 Watts during said third plasma process.

20. The method of claim 14, wherein, prior to executing said second plasma process, said set of contaminants is situated on a showerhead housed in said process chamber.
